(19) United States
(12) Patent Application Publication
(10) Pub. No.: US 2009/0035519 A1
(43) Pub. Date: Feb. 5, 2009

(54) ABRASIVE ARTICLE WITH ANTI-SLIP POLYMERIC LAYER

(75) Inventors: Anthony C. Gaeta, Lockport, NY (US); Paul S. Goldsmith, Wayland, MA (US); Kamran Khatami, East Greenwich, RI (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignees: SAINT-GOBAIN ABRASIVES, INC., Worcester, MA (US); SAINT-GOBAIN ABRASIFS, Conflans-Sainte-Honorine (FR)

(21) Appl. No.: 12/184,810

(22) Filed: Aug. 1, 2008

Related U.S. Application Data
(60) Provisional application No. 60/953,909, filed on Aug. 3, 2007.

(51) Int. Cl. C09K 3/14

(52) U.S. Cl. 428/143; 428/141; 51/298

(57) ABSTRACT

An abrasive article includes a backing having first and second major surfaces, an abrasive layer overlying the first major surface, and a polymeric layer overlying the second major surface. The polymeric layer includes an elastomeric material having a Shore A durometer of about 55 to about 95.

### CROSS-REFERENCE TO RELATED APPLICATIONS

The present application claims priority from U.S. Provisional Patent Application No. 60/953,909 filed Aug. 3, 2007, entitled “ABRASIVE ARTICLE WITH ADHESION PROMOTING LAYER,” naming inventors Anthony C. Gaeta, Paul S, Goldsmith, and Kamran Khatami, which application is incorporated by reference herein in its entirety.

### FIELD OF THE DISCLOSURE

This disclosure, in general, relates to abrasive articles that have an anti-slip polymeric layer.

### BACKGROUND

Abrasive articles, such as coated abrasives and bonded abrasives, are used in various industries to machine workpieces, such as by lapping, grinding, or polishing. Machining utilizing abrasive articles spans a wide industrial scope from optics industries, automotive paint repair industries, to metal fabrication industries. In each of these examples, manufacturing facilities use abrasives to remove bulk material or affect surface characteristics of products.

Surface characteristics include shine, texture, and uniformity. For example, manufacturers of metal components use abrasive articles to fine and polish surfaces, and oftentimes desire a uniformly smooth surface. Similarly, optics manufacturers desire abrasive articles that produce defect free surfaces to prevent light diffraction and scattering.

While the abrasive surfaces of the abrasive article generally influence stock removal rate and surface quality, a poor backing material can lead to degradation in other performance factors, such as machine wear and performance. For example, typical backing materials cause wear of mechanical components that secure the abrasive article. In particular, coated abrasive tapes and belts that advance through mechanical systems may wear shoes, back supports, and drums. Further, traditional backing materials may permit swarf and dislodged abrasive grains to become entrained between the backing and support components, causing wear.

To compensate for entrainment of swarf and grains, some manufacturers have turned to anti-static and hard surface coatings. However, such coatings often are difficult for a machine to secure, reducing machine performance. For example, such coated backings often lead to poor advancement of abrasive tape products through a machine or lead to bunching of tape in grind areas of the machine, each of which lead to down-time for repairs.

In order to secure the abrasive article to the tooling machine, backings are typically coated with anti-slip layers containing abrasive mineral fillers. Although the anti-slip layer increases the adhesion of the abrasive tape to the tooling machine, the traditional anti-slip layers and the abrasive mineral fillers result in tool wear. In particular, the abrasive mineral fillers can ultimately affect the life of the machine.

As such, an improved abrasive product including an improved backing material would be desirable.

### SUMMARY

In a particular embodiment, an abrasive article includes a backing having first and second major surfaces, an abrasive layer overlying the first major surface, and a polymeric layer overlying the second major surface. The polymeric layer includes an elastomeric material having a Shore A durometer of about 55 to about 95.

In another embodiment, an abrasive article includes a backing having first and second major surfaces. The backing is formed of a polyester film. An abrasive layer overlies the first major surface and the abrasive layer includes abrasive grains and a binder. A polymeric layer overlies the second major surface without intervening layers. The polymeric layer includes an elastomeric material having a Shore A durometer of about 75 to about 95, wherein the polymeric layer is free of surface structures.

In another embodiment, an abrasive article includes a backing film having first and second major surfaces. An abrasive layer overlies the first major surface and a polymeric layer overlies the second major surface. The polymeric layer includes an elastomeric material having a Total Cut Parameter of not greater than about 0.020 grams.

In yet another embodiment, a method of forming an abrasive article includes providing a backing film having first and second major surfaces. The backing film includes a polyester film that forms the first major surface and an elastomeric polymer film that forms the second major surface. The elastomeric polymer film has a Shore A durometer of about 75 to about 95. The method further includes coating an abrasive layer to overlie the first major surface of the backing film.

In a further embodiment, a method of abrading mechanical components includes locating a first portion of an abrasive tape in an abrading machine. The abrasive tape includes a backing film having first and second major surfaces, an abrasive layer overlying the first major surface, and an elastomeric polymer layer overlying the second major surface. The method further includes rotating a first mechanical component in contact with the first portion of the abrasive tape, advancing the abrasive tape through the abrading machine to expose a second portion of the abrasive tape, and rotating a second mechanical component in contact with the second portion of the abrasive tape.

### BRIEF DESCRIPTION OF THE DRAWINGS

The present disclosure may be better understood, and its numerous features and advantages made apparent to those skilled in the art by referencing the accompanying drawing.

FIG. 1 includes an illustration of an exemplary abrasive article.

FIG. 2 is a flow chart illustrating a method of forming an abrasive article.

FIG. 3 in an illustration of exemplary crankshaft grinding equipment.

FIG. 4 is a flow chart illustration of a method of abrading mechanical components.

### DESCRIPTION OF THE DRAWINGS

In a particular embodiment, an abrasive article includes a backing having a first major surface and a second major surface. The abrasive article includes an abrasive layer overlying the first major surface. A polymeric layer overlies the second major surface of the backing. In an exemplary embodiment, the polymeric layer may be disposed directly on and may directly contact the second major surface of the backing without any intervening layers or tie layers. In another embodiment, the backing may be surface treated, chemically treated, primed, or any combination thereof. In particular, the polymeric layer provides a desirable non-abrasive layer to the backing as well as provides an abrasive article with desirable frictional characteristics.

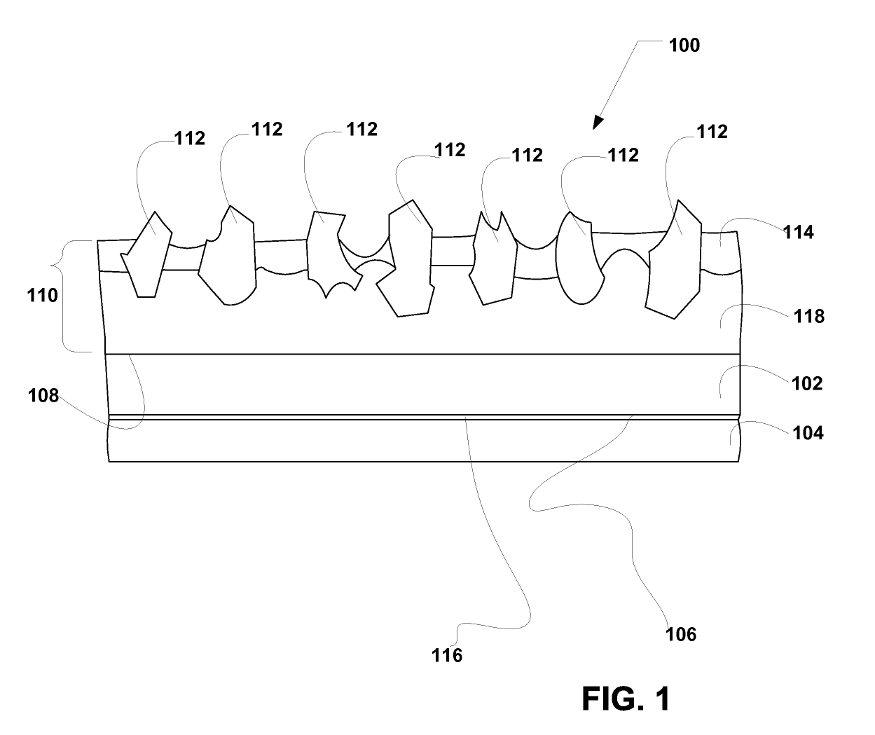

An exemplary embodiment of a coated abrasive article 100 is illustrated in FIG. 1. The coated abrasive includes a backing 102 and a polymeric layer 104 disposed over the second major surface 106 of the backing 102. Disposed on the first major surface 108 of the backing 102 is an abrasive layer 110 in contact with abrasive grains 112. The abrasive layer 110, such as a make coat layer 118, is disposed over the first major surface 108 of the backing 102. Further, the coated abrasive 100 may include a size coat 114, a supersize coat (not illustrated) overlying the size coat 114, or an adhesion promoting layer (not illustrated) between the backing 102 and the make coat 110.

The backing 102 of the abrasive article may be flexible or rigid and may be made of various materials. An exemplary flexible backing includes a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, or rayon); paper; vulcanized paper; vulcanized rubber; vulcanized fiber; nonwoven materials; any combination thereof, or any treated version thereof. Cloth backings may be woven or stitch bonded. In particular examples, the backing is selected from the group consisting of paper, polymer film, cloth, cotton, poly-cotton, rayon, polyester, poly-nylon, vulcanized rubber, vulcanized fiber, metal foil or any combination thereof. In an exemplary embodiment, the backing includes a thermoplastic film, such as a polyethylene terephthalate (PET) film. In particular, the backing may be a single layer polymer film, such as a single layer PET film. An exemplary rigid backing includes a metal plate, a ceramic plate, or the like.

Typically, the backing 102 has a thickness of at least about 50 microns, such as greater than about 75 microns. For example, the backing 102 may have a thickness of greater than about 75 microns and not greater than about 200 microns, or greater than about 75 microns and not greater than about 150 microns.

In an exemplary embodiment, the polymeric layer 104 is formed from a material having desirable elastomeric properties. In an embodiment, the material having desirable elastomeric properties is a diene elastomer or a thermoplastic material. For example, the thermoplastic material may include a thermoplastic vulcanate, a thermoplastic olefin, or a thermoplastic polyurethane. In a particular example, the elastomeric material is unfunctionalized. For example, the elastomeric material may not include functional groups extending from the backbone or terminal ends of the molecules forming the elastomeric material. In particular, unfunctionalized elastomeric material as used herein includes a polymer that is free of functional groups that include elements such as halogen, oxygen, nitrogen, sulfur, or phosphorus, while the polymer itself may include such elements within the backbone.

In a particular embodiment, the polymeric layer 104, for example, may be formed of an elastomeric material. In a particular embodiment, the elastomeric material includes a crosslinkable elastomeric polymer. For example, the polymeric layer 104 may include a diene elastomer. In an exemplary embodiment, the diene elastomer is a copolymer formed from at least one diene monomer. For example, the diene elastomer may be a copolymer of ethylene, propylene and diene monomer (EPDM). An exemplary diene monomer includes a conjugated diene, such as butadiene, isoprene, chloroprene, or the like; a non-conjugated diene including from 5 to about 25 carbon atoms, such as 1,4-pentadiene, 1,4-hexadiene, 1,5-hexadiene, 2,5-dimethyl-1,5-hexadiene, 1,4-octadiene, or the like; a cyclic diene, such as cyclopentadiene, cyclohexadiene, cyclooctadiene, dicyclopentadiene, or the like; a vinyl cyclic ene, such as 1-vinyl-1-cyclopentene, 1-vinyl-1-cyclohexene, or the like; an alkylbicyclononadiene, such as 3-methylbicyclo-(4,2,1)-nona-3,7-diene, or the like; an indene, such as methyl tetrahydroindene, or the like; an alkenyl norbornene, such as 5-ethylidene-2-norbornene, 5-butylidene-2-norbornene, 2-methallyl-5-norbornene, 2-isopropenyl-5-norbornene, 5-(1,5-hexadienyl)-2-norbornene, 5-(3,7-octadienyl)-2-norbornene, or the like; a tricyclodiene, such as 3-methyltricyclo (5,2,1,0²,6)-deca-3,8-diene or the like; or any combination thereof. In a particular embodiment, the diene includes a non-conjugated diene. In another embodiment, the diene elastomer includes alkenyl norbornene. The diene elastomer may include, for example, ethylene from about 63 wt % to about 95 wt % of the polymer, propylene from about 5 wt % to about 37 wt %, and the diene monomer from about 0.2 wt % to about 15 wt %, based upon the total weight of the diene elastomer. In a particular example, the ethylene content is from about 70 wt % to about 90 wt %, propylene from about 17 wt % to about 31 wt %, and the diene monomer from about 2 wt % to about 10 wt % of the diene elastomer. The uncrosslinked diene elastomer may have an elongation at break of at least about 600 percent. In general, the diene elastomer includes a small amount of a diene monomer, such as a dicyclopentadiene, a ethylnorbornene, a methylnorbornene, a non-conjugated hexadiene, or the like, and typically has a number average molecular weight of from about 50,000 to about 100,000. Exemplary diene elastomers are commercially available under the tradename Nordel from Dow, such as Nordel IP 4725P.

In a particular embodiment, the material of polymeric layer 104 includes greater than about 40 wt % of the diene elastomer. For example, the polymeric layer 104 may include greater than about 50 wt % diene elastomer, such as greater than about 65 wt %, greater than about 80 wt %, or even, greater than about 90 wt % of the diene elastomer. In a particular example, the material of layer 104 consists essentially of a diene elastomer, such as EPDM.

In an exemplary embodiment, the polymeric layer 104 may include an olefinic polymer. Herein, olefinic polymer includes a homopolymer or a copolymer formed from at least one alkylene monomer. For example, an olefinic polymer may include a polyolefin or a diene elastomer. An example of the olefinic polymer includes a polyolefin homopolymer, such as polyethylene, polypropylene, polybutene, polypentene, polystyrene, or polymethylpentene; a polyolefin copolymer, such as a modified styrene copolymer, ethylene-propylene copolymer, ethylene-butene copolymer, or ethylene-octene copolymer; a thermoplastic olefin (TPO); or any blend or combination thereof. In a particular example, the olefinic polymer includes a thermoplastic olefin (TPO). An exemplary polyethylene includes high density polyethylene (HDPE), medium density polyethylene (MDPE), low density polyethylene (LDPE), ultra low density polyethylene, or any combination thereof.

In a particular example, the elastomeric material includes a thermoplastic vulcanate, such as a blend of a diene elastomer and a polyolefin. The polyolefin of the blend may include a homopolymer, a copolymer, a terpolymer, an alloy, or any combination thereof formed from a monomer, such as ethylene, propylene, butene, pentene, methyl pentene, octene, or any combination thereof. An exemplary polyolefin includes high density polyethylene (HDPE), medium density polyethylene (MDPE), low density polyethylene (LDPE), ultra low density polyethylene, ethylene propylene copolymer, ethylene butene copolymer, polypropylene (PP), polybutene, polypentene, polymethylpentene, polystyrene, ethylene propylene rubber (EPR), ethylene octene copolymer, or any combination thereof. In a particular example, the polyolefin includes high density polyethylene. In another example, the polyolefin includes polypropylene. In a further example, the polyolefin includes ethylene octene copolymer. In a particular embodiment, the polyolefin is not a modified polyolefin, such as a carboxylic functional group modified polyolefin, and in particular, is not ethylene vinyl acetate. In addition, the polyolefin is not formed from a diene monomer. An exemplary commercially available polyolefin includes Equistar 8540, an ethylene octene copolymer; Equistar GA-502-024, an LLDPE; Dow DMDA-8904NT 7, an HDPE; Basell Pro-Fax SR275M, a random polypropylene copolymer; Dow 7C50, a block PP copolymer; or products formerly sold under the tradename Engage by Dupont Dow. Another exemplary resin includes Exxon Mobil Exact 0201 or Dow Versify 2300.

In an example, the blend of EPDM and polyolefin may include not greater than about 40 wt % polyolefin, such as not greater than about 30 wt % polyolefin. For example, the blend may include not greater than about 20 wt % of the polyolefin, such as not greater than 10 wt % polyolefin. In a particular example, the blend includes about 5 wt % to about 30 wt %, such as about 10 wt % to about 30 wt %, about 10 wt % to about 25 wt %, or about 10 wt % to about 20 wt % of the polyolefin.

In general, the blend of EPDM and polyolefin exhibits compatibility between the polymeric components. DMA analysis may provide evidence of compatibility. DMA analysis may show a single tan delta peak between glass transition temperatures of major components of a blend, indicating compatibility. Alternatively, an incompatible blend may exhibit more than one tan delta peak. In an example, the blend may exhibit a single tan delta peak. In particular, the single tan delta peak may be between the glass transition temperature of the polyolefin and the glass transition temperature of the diene elastomer.

In an example, the polymeric layer 104 includes thermoplastic polyurethanes. Thermoplastic polyurethanes are the formed from at least one polyol and at least polyisocyanate. Polyols include, for example, polyethers and polyesters. Polyisocyanates may be aliphatic or aromatic. Thermoplastic polyurethanes include, for example, polyether-based polyurethanes, polyester-based polyurethanes, polyether/polyester hybrid polyurethanes, or any combination thereof. Exemplary commercially available thermoplastic polyurethanes include Bayer Desmopan and GLS Versollan.

In an embodiment, the elastomeric material of the polymeric layer 104 has a shore A durometer of about 55 to about 95, such as about 75 to about 95, or even about 85 to about 95. In an embodiment, the thermoplastic material of the polymeric layer 104 has a shore D durometer of not greater than about 65, such as not greater than about 55, such as not greater than about 50. The modulus of elasticity for the thermoplastic material is typically about 0.005 GPa to about 0.5 GPa.

The polymeric layer 104 may also include optional components such as soft fillers. Soft fillers include materials such as talc, graphite, and any combination thereof. In an exemplary embodiment, the material of polymeric layer 104 may include a crosslinking agent, a photoinitiator, a thermal initiator, a filler, a pigment, an antioxidant, a flame retardant, a plasticizer, or any combination thereof. Alternatively, the layers 104 may be free of crosslinking agents, photoinitiators, thermal initiators, fillers, pigments, antioxidants, flame retardants, or plasticizers. In particular, the layer 104 may be free of photoinitiators or crosslinking agents. In an exemplary embodiment, the polymeric layer 104 is typically free of any surface structures. Further, the polymeric layer 104 may be free of abrasive particulate.

In an exemplary embodiment, the material of the polymer layer 104 is thermoplastic and is polymerized prior to application on the backing 102. In an exemplary embodiment, the thermoplastic material of the polymeric layer 104 is fully polymerized and does not further cure after coating. Alternatively, the material of the polymeric layer 104 may be cured through cross-linking. In a particular example, the polymeric layer 104 may be crosslinkable through radiation, such as using x-ray radiation, gamma radiation, ultraviolet electromagnetic radiation, visible light radiation, electron beam (e-beam) radiation, or any combination thereof. Ultraviolet (UV) radiation may include radiation at a wavelength or a plurality of wavelengths in the range of from 170 nm to 400 nm, such as in the range of 170 nm to 220 nm. Ionizing radiation includes high-energy radiation capable of generating ions and includes electron beam (e-beam) radiation, gamma radiation, and x-ray radiation. In a particular example, e-beam ionizing radiation includes an electron beam generated by a Van de Graaff generator or an electron-accelerator. In an alternative embodiment, the polymeric layer 104 may be cured through thermal methods.

Typically, the polymeric layer 104 has a thickness of about 25 microns to about 75 microns. In a particular embodiment, the polymeric layer 104 is bonded directly to and directly contacts the backing 102. For example, the polymeric layer 104 may be directly bonded to and may directly contact the backing 102 without an intervening adhesion enhancement layer. In an embodiment, the backing may be treated to increase the adhesion between the backing 102 and the polymeric layer 104. Treatment may include surface treatment, chemical treatment, use of a primer, or any combination thereof. In an exemplary embodiment, the treatment may include corona treatment, UV treatment, electron beam treatment, flame treatment, scuffing, or any combination thereof. Alternatively, an adhesion enhancement layer may be used to enhance adhesion of the backing 102 and polymeric layer 104. As illustrated, an optional adhesion enhancement layer 116 may be formed to underlie polymeric layer 104 to improve adhesion between the polymeric layer 104 and the backing 102. In particular, the optional adhesion enhancement layer 116 may be disposed between the backing 102 and the polymeric layer 104. An exemplary primer used as the optional adhesion enhancement layer 116 may include a chemical primer that increases the adhesion between the backing 102 and the polymeric layer 104. An exemplary chemical primer is a polyethylene imine primer. In an embodiment, the optional adhesion enhancement layer 116 is a copolymer including at least one ethylene monomer and at least one monomer of acrylic acid, ethyl acrylic acid, or methyl acrylic acid. Typically, the optional adhesion enhancement layer 116 has a thickness of not greater than about 5 microns, such as not greater than about 3 microns, such as not greater than about 2.5 microns.

In particular, the polymeric layer 104 is compatible with cooling fluids. For example, the polymeric layer 104 may not disintegrate, dissolve, or delaminate in the presence of the cooling fluid. In an example, the polymeric layer 104 may be compatible with cooling fluids, such as deionized water, mineral oil-based cooling fluids, or Syntilo or Honilo products by Castrol,

The abrasive article 100 further includes an abrasive layer 110 overlying the first major surface 108 of the backing 102. In an exemplary embodiment, the abrasive layer 110 may directly contact the first major surface 108 of the backing 102 without any intervening layers or tie layers between the first major surface of the backing and the abrasive layer. In another embodiment, the backing 102 on the first major surface 108 may be surface treated, chemically treated, primed, or any combination thereof to increase the adhesion between the backing 102 and the abrasive layer 110. In particular, the abrasive layer 110 may include an adhesion promoting layer (not illustrated) between the backing 102 and the make coat layer 118. The abrasive layer 110 may be formed as one or more coats. Generally, the abrasive layer 110 is formed of a binder or make coat layer 118, and abrasive grains 112 that overlie the first major surface 108 of the backing 102. In an exemplary embodiment, the abrasive grains 112 are blended with a binder formulation to form abrasive slurry that is used to form the abrasive layer 110. Alternatively, the abrasive grains 112 are applied over the binder formulation after the binder formulation is coated over the first major surface 108 of the backing 102 to form the make coat layer 118. In addition, a size coat 114 may be applied over the make coat layer 118 and the abrasive grains 112.

Particular coated abrasives include engineered or structured abrasives that generally include patterns of abrasive structures. Optionally, a functional powder may be applied over the abrasive layer 110 to prevent the abrasive layer 110 from sticking to a patterning tooling. Alternatively, patterns may be formed in the abrasive layer 108 absent a functional powder.

In an example, a binder may be formed of a single polymer or a blend of polymers. The binder can be used to form a make coat 118, a size coat 114, a supersize coat, or any combination thereof. For example, the binder may be formed from epoxy, acrylic polymer, or a combination thereof. In addition, the binder may include filler, such as nano-sized filler or a combination of nano-sized filler and micron-sized filler. In a particular embodiment, the binder includes a colloidal binder, wherein the formulation that is cured to form the binder is a colloidal suspension including particulate filler. Alternatively, or in addition, the binder may be a nanocomposite binder or coating material including sub-micron particulate filler.

The binder generally includes a polymer matrix, which binds the abrasive grains 112 to the abrasive layer 110. Typically, the binder is formed of cured binder formulation. For the preparation of the polymer component, the binder formulation may include one or more reaction constituents or polymer constituents. A polymer constituent may include a monomeric molecule, an oligomeric molecule, a polymeric molecule, or a combination thereof. The polymer constituents can form thermoplastics or thermosets. The binder formulation may further include components such as dispersed filler, solvents, plasticizers, chain transfer agents, catalysts, stabilizers, dispersants, curing agents, reaction mediators, or agents for influencing the fluidity of the dispersion. In addition to the above constituents, other components may also be added to the binder formulation, including, for example, anti-static agents, such as graphite, carbon black, and the like; suspending agents, such as fumed silica; anti-loading agents, such as zinc stearate; lubricants such as wax; wetting agents; dyes; fillers; viscosity modifiers; dispersants; defoamers; or any combination thereof.

To form an abrasive layer, abrasive grains may be included within the binder or deposited over the binder. The abrasive grains may be formed of any one of or a combination of abrasive grains, including silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery, or any combination thereof. For example, the abrasive grains may be selected from a group consisting of silica, alumina, zirconia, silicon carbide, silicon nitride, boron nitride, garnet, diamond, cofused alumina zirconia, ceria, titanium diboride, boron carbide, flint, emery, alumina nitride, or a blend thereof. In a further example, the abrasive grain may be formed of an agglomerated grain. Particular embodiments have been created by use of dense abrasive grains comprised principally of alpha-alumina.

The abrasive grain may also have a particular shape. An example of such a shape includes a rod, a triangle, a pyramid, a cone, a solid sphere, a hollow sphere, or any combination thereof. Alternatively, the abrasive grain may be randomly shaped.

The abrasive grains generally have an average grain size not greater than 2000 microns, such as not greater than about 1500 microns. In another example, the abrasive grain size is not greater than about 750 microns, such as not greater than about 350 microns. For example, the abrasive grain size may be at least 0.1 microns, such as from about 0.1 microns to about 1500 microns, and more typically from about 0.1 microns to about 200 microns, or from about 1 micron to about 100 microns. The grain size of the abrasive grains is typically specified to be the longest dimension of the abrasive grain. Generally, there is a range distribution of grain sizes. In some instances, the grain size distribution is tightly controlled.

In a blended abrasive slurry including the abrasive grains and the binder formulation, the abrasive grains provide from about 10.0% to about 90.0%, such as from about 30.0% to about 80.0%, of the weight of the abrasive slurry.

The abrasive slurry further may include a grinding aid to increase the grinding efficiency and cut rate. A useful grinding aid can be inorganic based, such as a halide salt, for example, sodium cryolite, and potassium tetrafluoroborate; or organic based, such as a chlorinated wax, for example, polyvinyl chloride. A particular embodiment of grinding aid includes cryolite and potassium tetrafluoroborate with particle size ranging from 1 micron to 80 microns, and most typically from 5 microns to 30 microns. The weight percent of grinding aid is generally not greater than about 50.0 wt %, such as from about 0.0 wt % to 50.0 wt %, and most typically from about 10.0 wt % to 30.0 wt % of the entire slurry (including the abrasive grains).

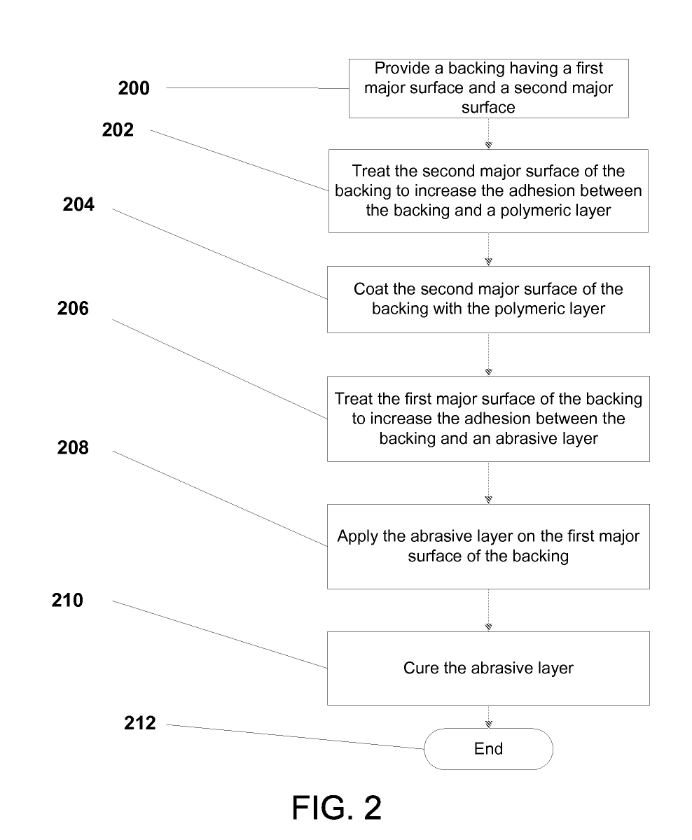

Referring to FIG. 2, an exemplary, non-limiting embodiment of a method of forming an abrasive article is shown and commences at block 200. At block 200, a backing is provided having a first and second major surface. As seen at block 202, the second major surface 106 of the backing 102 may be treated to increase the adhesion between the polymeric layer 104 and the backing 102. In an embodiment, treatment includes forming an optional adhesion enhancement layer 116. As seen at block 204, the polymeric layer 104 is then coated onto the backing 102. Coating may include extrusion coating, emulsion coating, or solution coating. In an exemplary process, the polymeric layer 104 is an elastomeric material that is extrusion coated onto the backing 102. Once coated on the backing, the polymeric layer 104 may be completely cured or may be at least partially cured and cured to completion at a later time. In an embodiment, the polymeric layer 104 is fully polymerized prior to coating and does not need further cure after coating.

The method of forming an abrasive article further includes applying an abrasive layer 110 to the backing 102. As seen at block 206, the backing 102 on the first major surface 108 may be treated to increase the adhesion between the backing 102 and the abrasive layer 110. In particular, the abrasive layer 110 may include an adhesion promoting layer (not illustrated) between the backing 102 and the abrasive layer 110. As seen in block 208, the abrasive layer 110 may be applied on the first major surface 108 of the backing 102. In an exemplary embodiment, the binder formulation may be disposed on the first major surface 108 of the backing 102 as a make coat 118. In an exemplary process for forming the abrasive layer 110, the binder formulation is coated on the backing 102, abrasive grains 112 are applied over the make coat 118, and the make coat 118 is at least partially cured, as seen at block 210. The abrasive grains 112 may be provided following coating of the backing 102 with the binder formulation, after partial curing of the binder formulation, after patterning of the binder formulation, or after fully curing the binder formulation. The abrasive grains 112 may, for example, be applied by a technique, such as electrostatic coating, drop coating or mechanical projection. In another exemplary embodiment, the binder formulation is blended with the abrasive grains 112 to form abrasive slurry that is coated on the backing 102, at least partially cured and optionally patterned.

Once the abrasive layer is cured, an abrasive article is formed. Alternatively, a size coat 114 may be applied over the abrasive layer 110. In an embodiment, a size coat 114 may be applied over the binder formulation and abrasive grains. For example, the size coat 114 may be applied before partially curing the binder formulation, after partially curing the binder formulation, after patterning the binder formulation, or after further curing the binder formulation. The size coat 114 may be applied by, for example, roll coating or spray coating. Depending on the composition of the size coat 114 and when it is applied, the size coat 114 may be cured in conjunction with the binder formulation or cured separately. A supersize coat including grinding aids may be applied over the size coat and cured with the binder formulation, cured with the size coat, or cured separately. The method can end at state 212.

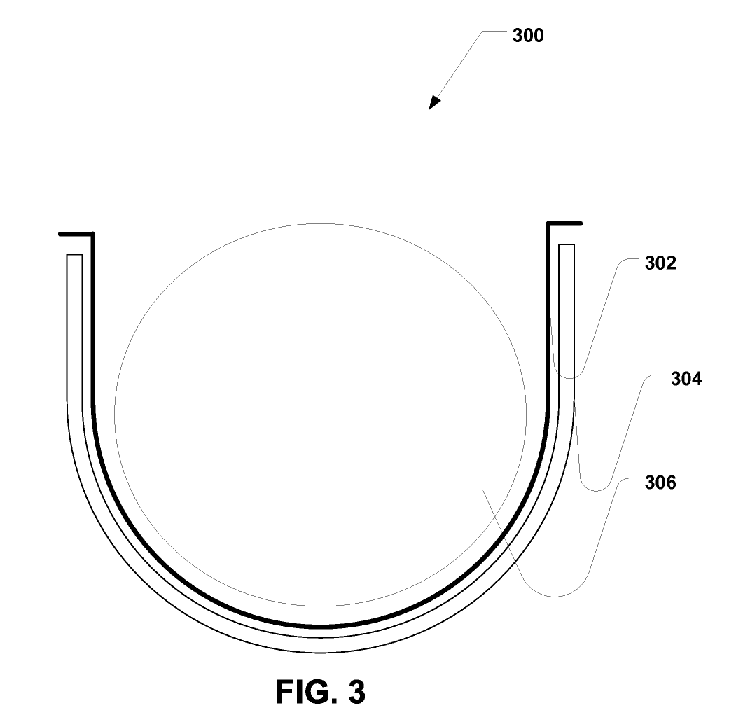

The abrasive articles may be formed into an abrasive strip, ribbon, or tape. In a particular embodiment, the abrasive tape is used to abrade mechanical components. Referring to FIG. 3, an exemplary, non-limiting embodiment of crankshaft grinding equipment is shown and is generally designated 300. Typically, the abrasive tape 302 is placed in the tooling machine 304. The abrasive tape 302 is placed in contact with the mechanical component such as a camshaft 306 and the component is rotated. As the abrasive tape is worn and ground on the mechanical components, more abrasive tape can be advanced to provide further abrasion.

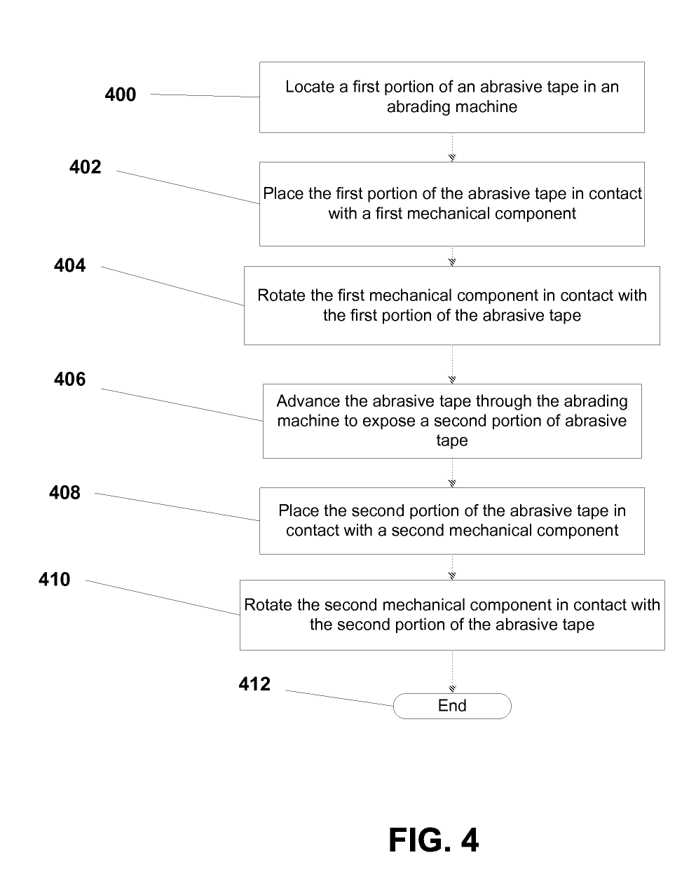

An exemplary method for abrading mechanical components can be seen in FIG. 4 and commences at block 400. At block 400, the method of abrading mechanical components includes placing a first portion of the abrasive tape in the abrading machine. Typically, at block 402, the abrasive tape is placed in contact with a first mechanical component. At block 404, the first mechanical component is then rotated to abrade the first mechanical component. At block 406, a second portion of the abrasive tape may then be advanced through the abrading machine. At block 408, the second portion of the abrasive tape is placed in contact with a second mechanical component. At block 410, the second mechanical component may then be rotated while in contact with the second portion of the abrasive tape. The method can end at state 412.

In a particular example, the abrasive article is in the form of a tape or ribbon having length, widths, and thickness dimensions. The ratio of the length to width dimensions is at least about 10:1, such as at least about 20:1, or even about 100:1.

Particular embodiments of the above abrasive articles and method advantageously provide improved performance. Such embodiments advantageously reduce wear of abrading equipment. For example, when used in the form of an abrasive ribbon, strip, or tape, such embodiments reduce wear on drums, shoes, and back supports. Further, embodiments of such tapes more easily advance through abrading machines without bunching and with reduced wear. In particular, the combination of layers having the disclosed polymeric layer may advantageously produce abrasive articles having desirable mechanical properties and desirable performance properties.

In an exemplary embodiment, the abrasive article advantageously provides an improved Total Cut Parameter, which is indicative of the abrasive nature of the backing against tooling. In contrast to a desirably higher material removal rate of the abrasive on an abraded product, a relatively lower material removal rate is desired on the tooling supporting the abrasive. The Total Cut Parameter is defined as the total cut (in grams) of the back side of the abrasive article over an acrylic sheet as determined in accordance with the method of Example 4 below. For instance, the Total Cut Parameter of the abrasive article against an acrylic panel may be not greater than about 0.020 grams, such as not greater than about 0.010 grams.

In an exemplary embodiment, the abrasive article may also provide an advantageous coefficient of friction. For instance, the dynamic coefficient of friction is at least about 0.30, such as at least about 0.50, or at least about 0.90, when dry tested under a total normal force of 400 grams. In an embodiment, the dynamic coefficient of friction is not greater than about 3.30, such as not greater than about 2.00, or not greater than about 1.00, when dry tested under a total normal force of 400 grams. The static coefficient of friction is at least about 0.30, such as at least about 0.50, or at least about 0.75, when dry tested under a total normal force of 400 grams. In an embodiment, the static coefficient of friction is not greater than about 6.10, such as not greater than 5.00, or not greater than about 1.00, when dry tested under a total normal force of 400 grams.

In an embodiment, the abrasive article may also provide an advantageous coefficient of friction when tested under wet conditions. For instance, when wet tested in mineral seed oil under a total normal force of 400 grams, the dynamic coefficient of friction is at least about 0.30, such as at least about 0.50 and the static coefficient of friction is at least about 0.30, such as at least about 0.50. In an embodiment, when wet tested in Syntilo 9930 (available from Castrol) under a total normal force of 400 grams, the dynamic coefficient of friction is at least about 0.35, such as at least about 0.40 and the static coefficient of friction is at least about 0.25, such as at least about 0.30. When we tested in a mix of Syntilo 9930 and diionized water (80/20 ratio) under a total normal force of 400 grams, the dynamic coefficient of friction is at least about 0.15, such as at least about 0.25 and the static coefficient of friction is at least about 0.15, such as at least about 0.20.

### EXAMPLE 1

Two polymeric layers are prepared for a performance study. Specifically, two thermoplastic materials, DOW 722 low density polyethylene (10:1 LDPE DOW 722:162895 Light Blue Concentrate) and Bayer Desmopan 385E TPU (85 Shore A) with 2.5% Clariant white concentrate, are extruded at a thickness of 50 microns and 100 microns, respectively, onto a 125 micron polyethylene terephthalate (PET) backing (DuPont Mylar A).

The coolant fluid resistance of the polymeric layers is evaluated. The samples are tested at room temperature with about 20 minutes of direct exposure to three coolant fluids: mineral seal oil, Syntilo 9930/diionized water mix (80/20 ratio), and Syntilo 9930. The Syntilo fluid is a coolant available from Castrol. The amount of coolant fluid is about 5 ml to about 10 ml and the surface of the polymeric layer is rubbed with a letter opener in an attempt to delaminate the coating. The coolant fluids do not affect the polymeric layers. The two samples are well wet by the fluids but did not swell, distort, or separate from the PET film.

### EXAMPLE 2

Three articles are prepared for a performance study. The composition of the coated articles can be seen in Table 1. Specifically, the thermoplastic materials described in Table 1 are extruded at a thickness of 50 microns onto a 75 micron polyethylene terephthalate (PET) backing. An adhesion promoting layer is also coated at a thickness of 25 microns onto the side of the backing opposite the polymeric layer. Disposed over the adhesion promoting layer is a 30 micron make/grain/size layer of water-based UV cured polyurethane (Neorad 3709) with fused silicone filler (Minisil 20). A comparison sample control film of Q154 (a 5 mil PET film coated with water based UV cured polyurethane (Neorad 3709) with fused silica filler (Minsil 20)) is also used.

TABLE 1
Composition of Articles

| | Polymeric layer | Adhesion promoting layer |
|---|---|---|
| Article 1 | Standard water based | DOW Amplify 101 |
| | UV cured polyurethane | |
| | (Neorad 3709) with fused | |
| | silica filler (Minsil 20) | |
| Article 2 | Low density polyethylene | Eastman SP2207 |
| | (LDPE) Dow 722 | |
| Article 3 | LDPE Dow 722/Kraton FG 1901 | Eastman SP2207 |
| | blend | |

All films are corona treated to about 48-55 dyne/cm² and coated with MICA AX131 polyethylene imine primer at 0.6 lb/ream (3000 ft²/ream) prior to extrusion coating with the polymeric layers and adhesion promoting layers.

The articles are tested on a crankshaft. Samples of 0.75 inches wide and 30 feet in length are placed on GM Gen. III steel billet cam shafts and tested in an IMPCO style 750, three lobe cam shaft grinder. The cam lobe is a diamond coated surface and the coolant is mineral seal oil-based coolant, Texaco ALMAG. The pressure varied from 22 psig to 68 psig with a cam shaft rotations per minute of 60. The grinding cycle is 8 seconds in both forward and reverse directions with a lateral oscillation of 400 cycles per minute with a 1/32 inch displacement.

There is abrasion of the diamond tool against the polymeric layer of Articles 2 and 3. However, the polymeric coatings of Articles 2 and 3 did not strip off or delaminate from the backing after the cam shaft grinding test. No slippage occurred at low clamping pressures from 22 psig to 40 psig. At higher clamping pressures, the LDPE/Kraton material slips more than the straight LDPE material. Even with slippage of the film, no stripping of the back coat is observed. Article 1 causes tool wear under all clamping pressures. An improvement in slippage of all the films is seen when the film is given a dwell time of about 30 seconds after closing the tooling and starting the machine.

The coolant fluid resistances of the articles are also evaluated. A four inch length of each sample is exposed to Castrol Honilo 480C and Castrol Honilo 980 for a period of 24 hours. The bottom inch of the sample is left immersed in the liquid, while the top three inches is allowed to “drip dry”. Drip-dried areas do not achieve complete dryness. Samples are inspected after 3.25 hours, 6 hours, 24 hours, and 144 hours. After 24 hours and 144 hours, the dry end of each sample is compared to the wet end of each sample by measuring thickness. Results can be seen in Table 2 and Table 3.

TABLE 2
Thickness of Article After Immersion in Honilo 480C

| Sample | Dry End | Wet End (24 hours) | Wet End (144 hours) |
|---|---|---|---|
| Control | 15 mil | 14.5 mil | 14.5 mil |
| Article 1 | 17 mil | 16.5 mil | 16.5 mil |
| Article 2 | 17 mil | 17.5 mil | 17.5 mil |
| Article 3 | 17 mil | 17 mil | 17.5 mil |

TABLE 3
Thickness of Article After Immersion in Honilo 980

| Sample | Dry End | Wet End (24 hours) | Wet End (144 hours) |
|---|---|---|---|
| Control | 15 mil | 15 mil | 14.9 mil |
| Article 1 | 17 mil | 17 mil | 17 mil |
| Article 2 | 17 mil | 17 mil | 17.2 mil |
| Article 3 | 16.5 mil | 17 mil | 17.2 mil |

The variation in the thickness of the dry and wet ends are considered within sample variation after both 24 and 144 hours. No difference in appearance is noted. The three articles demonstrate equivalent coolant resistance compared to the control sample.

### EXAMPLE 3

The coefficient of friction test is performed according to ASTM D11894-01 on a TMI Monitor/Slip and Friction tester, Model No. 32-06. A 200 gram sled has 200 grams of added weight for a total normal force of 400 grams with a feed rate of 150 mm/minute. The test substrate was a 2 inch by 6 inch PSTC stainless steel panel. The friction coefficient is tested under dry conditions and wet conditions using the coolant fluids described in Example 1. Results can be seen in Tables 4 through 11. Comparison samples of 3M products, Q151 (a 5 mil PET film coated with water based UV cured polyurethane (Neorad 3709) with fused silica filler (Minsil 20), and a PET control film are included.

TABLE 4
Static COF, Dry Test.

| | Friction |
|---|---|
| Polymeric layer, thickness, width × length | coefficient |
| 3M 372L, 40 microns, 1″ × 2.5″ | 0.12 |
| 3M 273L 30 micron (grit size), 15/16″ × 2.5″ | 0.29 |
| Q151 50 micron (grit size), 1″ × 2.5″ | 0.27 |
| PET film, 5 mil thickness, 1″ × 2.5″ (Control) | 0.13 |
| Desmopan 6065A TPU, 2.5 mil thickness, 1″ × 2.5″ | 6.03 |
| Dow Nordell 4820P EPDM, 2.5 mil thickness, 1″ × 2.5″ | 0.52 |
| Desmopan 385E, 4 mil thickness, 1″ × 2.5″ | 0.90 |
| LDPE (10:1 LDPE 722:162895 light blue concentrate), 2 mil | 0.32 |
| thickness, 1″ × 2.5″ | |

TABLE 5
Dynamic COF, Dry Test.

| | Friction |
|---|---|
| Polymeric layer, thickness, width × length | coefficient |
| 3M 372L 40 micron (grit size), 1″ × 2.5″ | 0.12 |
| 3M 273L 30 micron (grit size), 15/16″ × 2.5″ | 0.25 |
| Q151 50 micron (grit size), 1″ × 2.5″ | 0.20 |
| PET film, 5 mil thickness, 1″ × 2.5″ (Control) | 0.09 |
| Desmopan 6065A TPU, 2.5 mil thickness, 1″ × 2.5″ | 3.22 |
| Dow Nordell 4820P EPDM, 2.5 mil thickness, 1″ × 2.5″ | 0.93 |
| Desmopan 385E, 4 mil thickness, 1″ × 2.5″ | 0.74 |
| LDPE (10:1 LDPE 722:162895 light blue concentrate), 50 | 0.35 |
| microns, 1″ × 2.5″ | |

TABLE 6
Static COF, Wet Test in Mineral Seal Oil.

| | Friction |
|---|---|
| Polymeric layer, thickness, width × length | coefficient |
| Q151 60 micron (grit size), 1″ × 2.5″ | 0.34 |
| Desmopan 385E, 4 mil thickness, 1″ × 2.5″ | 0.52 |
| LDPE (10:1 LDPE 722:162895 light blue concentrate), 2 mil | 0.30 |
| thickness, 1″ × 2.5″ | |

TABLE 7
Dynamic COF, Wet Test in Mineral Seal Oil.

| | Friction |
|---|---|
| Polymeric layer, thickness, width × length | coefficient |
| Q151 60 micron (grit size), 1″ × 2.5″ | 0.34 |
| Desmopan 385E, 4 mil thickness, 1″ × 2.5″ | 0.59 |
| LDPE (10:1 LDPE 722:162895 light blue concentrate), 2 mil | 0.30 |
| thickness, 1″ × 2.5″ | |

TABLE 8
Static COF, Wet Test in Syntilo 9930/DI Water, 80/20.

| | Friction |
|---|---|
| Polymeric layer, thickness, width × length | coefficient |
| Q151 60 micron (grit size), 1″ × 2.5″ | 0.39 |
| Desmopan 385E, 4 mil thickness, 1″ × 2.5″ | 0.23 |
| LDPE (10:1 LDPE 722:162895 light blue concentrate), 2 mil | 0.16 |
| thickness, 1″ × 2.5″ | |

TABLE 9
Dynamic COF, Wet Test in Syntilo 9930/DI Water, 80/20.

| | Friction |
|---|---|
| Polymeric layer, thickness, width × length | coefficient |
| Q151 60 micron (grit size), 1″ × 2.5″ | 0.38 |
| Desmopan 385E, 4 mil thickness, 1″ × 2.5″ | 0.30 |
| LDPE (10:1 LDPE 722:162895 light blue concentrate), 2 mil | 0.19 |
| thickness, 1″ × 2.5″ | |

TABLE 10
Static COF, Wet Test in Syntilo 9930.

| | Friction |
|---|---|
| Polymeric layer, thickness, width × length | coefficient |
| Q151 60 micron (grit size), 1″ × 2.5″ | 0.40 |
| Desmopan 385E, 4 mil thickness, 1″ × 2.5″ | 0.34 |
| LDPE (10:1 LDPE 722:162895 light blue concentrate), 2 mil | 0.32 |
| thickness, 1″ × 2.5″ | |

TABLE 11
Dynamic COF, Wet Test in Syntilo 9930.

| | Friction |
|---|---|
| Polymeric layer, thickness, width × length | coefficient |
| Q151 60 micron (grit size), 1″ × 2.5″ | 0.40 |
| Desmopan 385E, 4 mil thickness, 1″ × 2.5″ | 0.44 |
| LDPE (10:1 LDPE 722:162895 light blue concentrate), 2 mil | 0.38 |
| thickness, 1″ × 2.5″ | |

Overall, the dynamic coefficient of friction follows the static coefficient of friction in trend. The polymeric layer shows good results for coefficient of friction compared to the Q151 control sample for both dry and wet conditions.

### EXAMPLE 4

A polyethylene terephthalate backing containing a polymeric layer is tested to determine the abrasiveness of the polymeric layer. A 40 micron grit size standard control film (Q151) is compared to an article with a polymeric layer and adhesion promoting layer AB1224328. The polymeric layer is a 2.0 mil Dow 722 LDPE+10% Ampacet 162895 Lt. Blue Concentrate. The adhesion promoting layer is a 1.0 mil Eastman Kodak Ethylene methyl acrylate copolymer (EMAC) SP2207+2% white concentrate. The abrasiveness of the samples are tested against an acrylic panel. The test method and conditions are as follows:

TABLE 12
Test Conditions

| Parameter | Setting |
|---|---|
| Coated Abrasive | 43.5 feet per minute |
| Speed | |
| Backup Pad | 80 Durometer (Shore A) Garlock #7797 Rubber Pad |
| | (1″ × 1.5″) |
| Tension | None |
| Grinding Aid | Water (On Automatic) |
| Test Piece | McMaster Carr Part # 8560K513, cast acrylic panels |
| | ( 3/16″ × 12″ × 24″) cut to 5⅞″ × 1 15/16″ |
| Test Piece Pressure | 644 Gram deadweight each side |
| Test Piece Speed | 0 |
| Time Intervals | 400 Strokes |
| Measurements | GRAMS CUT |
| Recorded | |
| Contact Angle | 0 Degrees (full face) |
| Air | Off |
| Product Soak | Dipped in water prior to test |

Sample preparation includes cutting the acrylic panels to the size listed above. The test pieces of the coated abrasive product are to be died out into a size of 1″×5″. The procedure includes the following steps:
Sand test panel according to parameters above
Remove the test pieces and thoroughly dry using precision wipe towels. Allow 1 minute to air dry.
Weigh the test pieces and record the final panel weight. Calculate the MRR (cut) of the product.

Exemplary total cut values are illustrated in Table 13.

TABLE 13
Total Cut Values

| Sample | Total Cut (grams) |
|---|---|
| Standard Sample #1 | 0.040500 |
| AB1224328 Sample #1 | 0.006500 |
| Standard Sample #2 | 0.030500 |
| AB1224328 Sample #2 | 0.002500 |
| Standard Sample #3 | 0.033500 |
| AB1224328 Sample #3 | 0.009500 |
| Standard Sample #4 | 0.020000 |
| AB1224328 Sample #4 | 0.007000 |

Overall, the AB1224328 samples have a much lower cut. Two film strips are run for each sample. The back sides of the film shows little wear or discoloration. Sample 4 is run twice to replicate low cut. The film has blue color. The backsides are tested. Samples are obtained and rerun.

The standard has a Total Cut Parameter of 0.031+/−0.009 grams and the PET backing with the polymeric layer has a Total Cut Parameter of 0.006+/−0.003.

The Total Cut Parameter of the PET backing with the polymeric layer is lower and hence, less abrasive to the tooling machine supporting the abrasive article than the standard control film.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. An abrasive article comprising:
a backing film including first and second major surfaces;
an abrasive layer disposed over the first major surface; and
a polymeric layer disposed over the second major surface, the polymeric layer including an elastomeric material having a Shore A durometer of about 55 to about 95.

2. The abrasive article of claim 1, wherein the polymeric layer is free of surface structures.

3. The abrasive article of claim 1, wherein the polymeric layer directly contacts the second major surface of the backing layer without intervening layers.

4. The abrasive article of claim 1, wherein the Shore A durometer is about 75 to about 95.

5. The abrasive article of claim 1, wherein the elastomeric material has a Shore D durometer of not greater than about 65.

6. (canceled)

7. (canceled)

8. The abrasive article of claim 1, wherein the elastomeric material has a modulus of elasticity of about 0.005 GPa to about 0.5 CPa.

9. The abrasive article of claim 1, wherein the elastomeric material is a thermoplastic polymeric material.

10. The abrasive article of claim 9, wherein the thermoplastic polymeric material is selected from the group consisting of thermoplastic polyurethane, thermoplastic elastomer polyolefin, thermoplastic vulcanate, and any combination thereof.

11. The abrasive article of claim 10, wherein the thermoplastic elastomeric polyolefin is selected from the group consisting of polyethylene, polybutene, and any combination thereof.

12. The abrasive article of claim 1, wherein the backing include polyester film.

13. The abrasive article of claim 12, wherein the polyester film includes polyethylene terephthalate.

14. The abrasive article of claim 1, wherein the abrasive article is in the form of a ribbon.

15. The abrasive article of claim 1, wherein the polymeric layer has a thickness of about 25 microns to about 75 microns.

16. The abrasive article of claim 1, wherein the polymeric layer is free of abrasive particulate.

17. The abrasive article of claim 1, wherein the polymeric layer includes a soft filler.

18. The abrasive article of claim 17, wherein the soft filler is selected from the group consisting of talc, graphite, and any combination thereof.

19. (canceled)

20. The abrasive article of claim 1, having a Total Cut Parameter of not greater than about 0.020 grams.

21. (canceled)

22. The abrasive article of claim 1, having a static coefficient of friction at least about 0.30.

23. (canceled)

24. The abrasive article of claim 1, having a dynamic coefficient of friction at least about 0.30.

25. (canceled)

26. An abrasive article comprising:
a backing including first and second major surfaces, the backing formed of a polyester film;
an abrasive layer disposed over the first major surface, the abrasive layer including abrasive grains and a binder; and
a polymeric layer disposed over and directly contacting the second major surface without intervening layers, the polymeric layer including an elastomeric material having a Shore A durometer of about 75 to about 95, wherein the polymeric layer being free of surface structures.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A method of forming an abrasive article, the method comprising:
providing a backing film having first and second major surfaces, the backing film including a polyester film forming the first major surface and an elastomeric polymer film forming the second major surface, the elastomeric polymer film having a Shore A durometer of about 75 to about 95; and
coating an abrasive layer to overlie the first major surface of the backing film.

46. (canceled)

47. (canceled)

48. (canceled)

49. (canceled)

50. (canceled)
